(19) United States
(12) Patent Application Publication
(10) Pub. No.: US 2020/0118125 A1
(43) Pub. Date: Apr. 16, 2020

(54) TOKEN-BASED PAYMENT TRANSACTION AUTHORIZED AT PAYMENT GATEWAY

(71) Applicant: MASTERCARD INTERNATIONAL INCORPORATED, Purchase, NY (US)

(72) Inventors: Manu Dharmaiah Kallugudde, Mumbai (IN); Satya Sudipta Padhiary, Mumbai (IN); Suken Bhayani, Mumbai (IN)

(21) Appl. No.: 16/161,446

(22) Filed: Oct. 16, 2018

(51) Int. Cl. G06Q 20/40; G06Q 20/38

(52) U.S. Cl. CPC G06Q 20/40; G06Q 20/3821; G06Q 20/385

(57) ABSTRACT

A method includes pre-authorizing a token entry at a payment gateway. The token entry is represented by a token. A transaction request is received at the payment gateway. The request is from a merchant and includes the payment token. The transaction request is related to an e-commerce transaction involving the merchant. The payment gateway responds to the payment request by authorizing the e-commerce transaction. The e-commerce transaction is charged to the token entry at the payment gateway.

### BACKGROUND

FIG. 1 is a block diagram that illustrates a conventional payment system 100.

The system 100 includes a customer device 102 by which a user 103 accesses an e-commerce server 104 via the internet 105. The customer device 102 may be any type of computing device usable to allow access to the internet, and runs a browser program (not separately shown) to enable interaction between the customer device 102 and the various resources available via the internet. The customer device 102 may be, for example, a personal computer, a laptop computer, a tablet computer or a mobile-browser-equipped smartphone or other mobile device. The e-commerce server 104 is typically a server computer operated by or on behalf of a merchant to host an online store/shopping website and to allow virtual visits to the website from customer devices. The e-commerce server 104 also operates to handle online-shopping transactions, typically funded by a payment system account owned by the user 103. In an online shopping transaction, the user 103 operates the customer device 102 to select one or more items for purchase, then elects to enter a checkout phase of the transaction, in which information that identifies the user's payment system account is provided to or accessed by the e-commerce server 104.

A computer 108 operated by an acquirer (acquiring financial institution) is also shown as part of the system 100 in FIG. 1. The acquirer may be a financial institution that provides payment account acceptance services to the merchant that operates the e-commerce server 104. The acquirer computer 108 may operate to receive a transaction authorization request message (“authorization request”) for the online shopping transaction from the e-commerce server 104. The acquirer computer 108 may route the authorization request via a payment network 110 (sometimes also referred to as a “card network”) to the server computer 112 operated by the issuer of the payment account that was specified during the checkout phase of the online shopping transaction. A transaction authorization response message (“authorization response”) generated by the payment account issuer server computer 112 may be routed back to the e-commerce server 104 via the payment network 110 and the acquirer computer 108.

One well known example of a payment network is referred to as the “Banknet” system, and is operated by Mastercard International Incorporated, which is the assignee hereof.

The payment account issuer server computer 112 may be operated by or on behalf of a financial institution (“FI”) that issues payment accounts to individual users and/or other entities. For example, the payment account issuer server computer 112 may perform such functions as (a) receiving and responding to requests for authorization of payment account transactions to be charged to payment accounts issued by the FI; (b) engaging in payment transaction clearing operations; and (c) tracking and storing transactions and maintaining account records.

In some instances, the transaction authorization request message is sent in the first instance from the e-commerce server to a so-called “payment gateway” (not shown). The payment gateway may operate on behalf of the acquirer bank and/or may provide transaction data processing functionality that the merchant's IT systems lack.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their e-commerce servers. The system may also include a very large number of payment account holders, who engage in online shopping transactions.

As is well known to those who are skilled in the art, a typical payment system like that shown in FIG. 1 may also handle numerous face to face purchase transactions at the point of sale in retail stores and other establishments. In a typical such transaction (not illustrated), the customer may present a payment card or other payment-enabled device (e.g., a payment-enabled mobile device) to a point of sale (POS) terminal. The POS terminal is operated by the merchant (or merchant's employee) to read payment account information from the card or device presented by the customer. An authorization request may originate from the POS terminal for routing to the account issuer, and the authorization response may be routed back to the POS terminal from the account issuer.

In some e-commerce transactions, the user enters the PAN (primary account number) for his/her payment card account during the checkout phase of interaction between the customer device and the e-commerce server. In other arrangements, there may be a “card-on-file” with the e-commerce server, so that the user does not have to enter his/her PAN. To enhance security, and help to protect the PAN from being intercepted by a wrongdoer, in a card-on-file arrangement the user's payment account may be represented by a payment token, which is a character string that serves as a replacement for the PAN during part of the transaction process. In various situations, the character string may be alphanumeric, or numeric characters only, or non-numeric characters only. For example, the payment token may be dedicated for use only in e-commerce transactions with the merchant in question.

The present inventors have now recognized an opportunity to enhance the convenience of e-commerce transactions.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates a payment system provided according to aspects of the present disclosure.

FIG. 3 is a block diagram that illustrates a computer system that may perform a role in the system of FIG. 2.

FIG. 4 is a simplified block diagram of a customer device that may perform a role in the system of FIG. 2.

FIG. 5 is a flow chart that illustrates a process that may be performed in the system of FIG. 2 according to aspects of the present disclosure.

### DETAILED DESCRIPTION

In general, and for the purpose of introducing concepts of embodiments of the present disclosure, a payment gateway may issue one or more payment tokens to a user. Funds underlying the payment tokens may be pre-authorized by the user's account issuer. The token or tokens may be on file with one or more merchants. During an e-commerce transaction, a transaction request including one of the tokens may be transmitted from the merchant to the payment gateway. The payment gateway may authorize the request without the transaction being routed through the payment network or to the account issuer.

With an arrangement of this kind, the authorization of the e-commerce transaction may be especially rapid as compared to a conventional e-commerce transaction. This may increase the convenience and appeal of online shopping transactions.

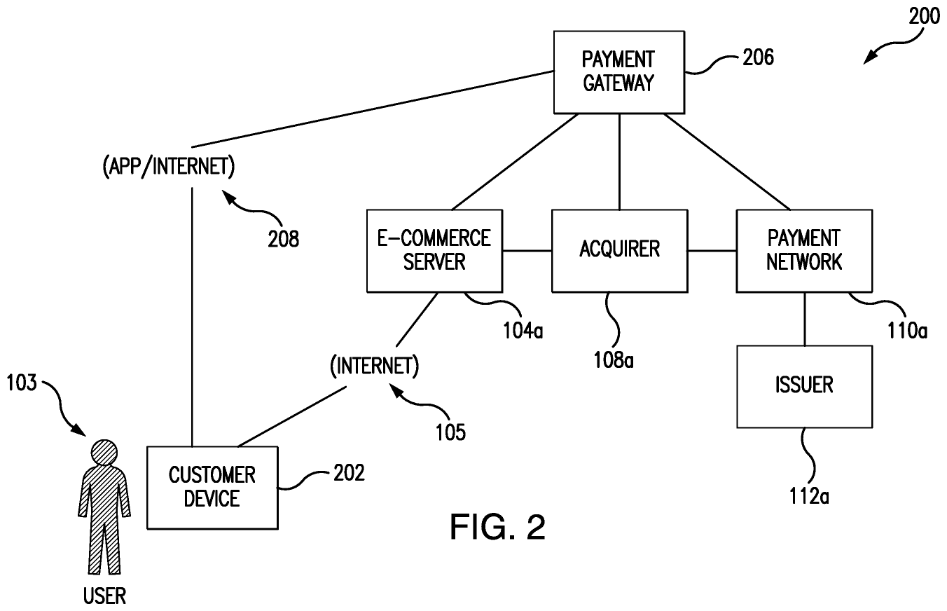

FIG. 2 is a block diagram that illustrates a payment system 200 provided according to aspects of the present disclosure.

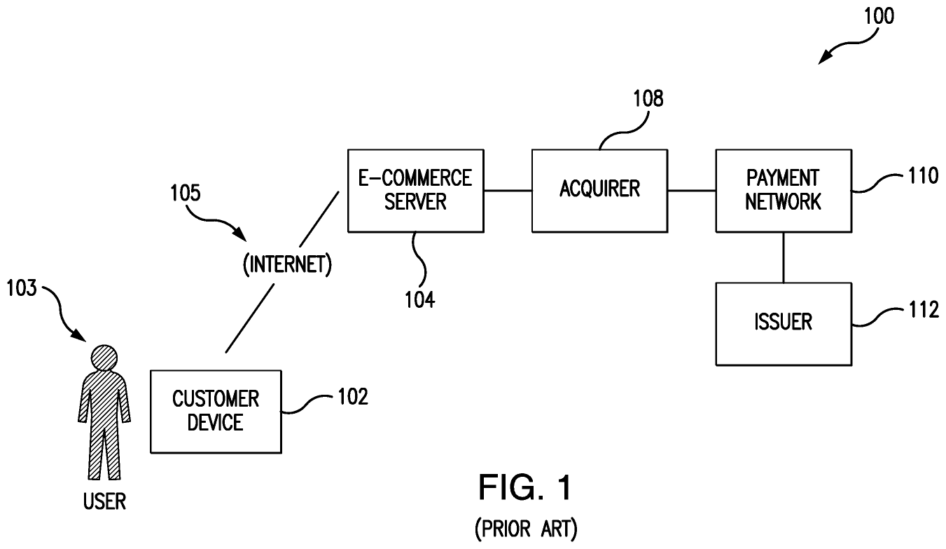

As in the system of FIG. 1, a user 103 is shown operating a customer device 202, so as to interact with an e-commerce server 104a via the internet 105. An acquirer 108a provides the e-commerce server (merchant) 104a with access to a payment network 110a. The system also includes an account issuer 112a, which is in communication with other system components via the payment network 110a. In accordance with aspects of the present disclosure, the system 200 further includes a payment gateway 206. Via in-app or internet communication 208, the customer device 202 interacts with the payment gateway 206 to arrange for the payment gateway 206 to issue tokens for use in card-on-file transactions with merchants, including the merchant that operates the e-commerce server 104a.

In some embodiments, the payment gateway 206 may be under common operation with the payment network 110a.

As was the case with the system as depicted in FIG. 1, FIG. 2 only shows components required for handling a single transaction. In a practical embodiment of the system 200, there may be numerous e-commerce servers, and customer devices, a large number of merchants' banks/acquirers and issuers, and potentially also a number of payment gateways. The system 200 may also handle transactions at the point of sale, and so may include many items of POS equipment like those referred to above. Still further, the system 200 may include a very large number of customer payment devices, such as cards, fobs, payment-enabled mobile devices, etc., for use in initiating transactions at the point of sale.

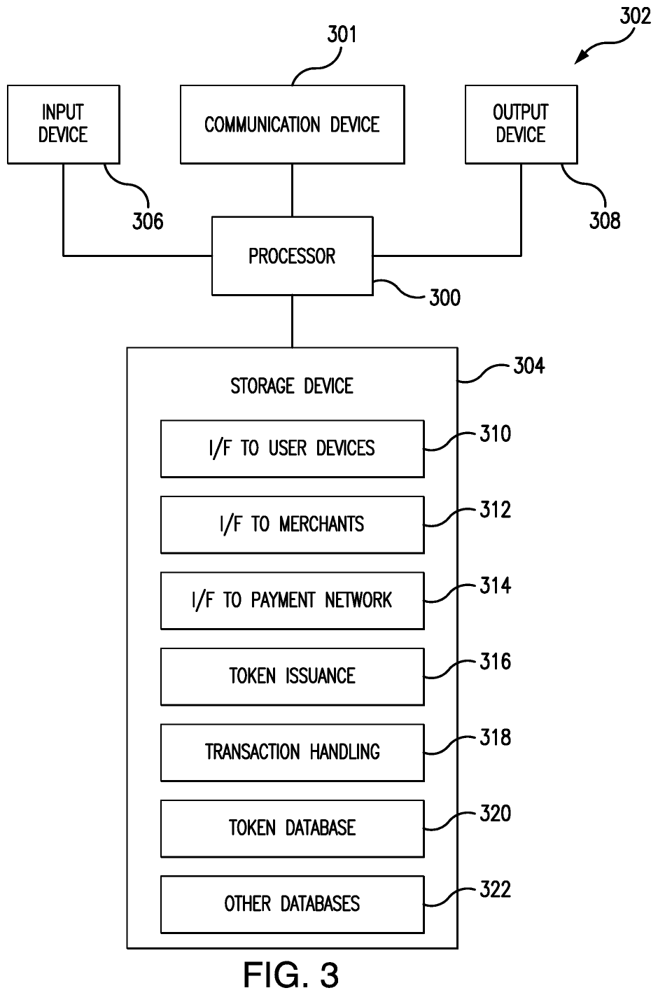

FIG. 3 is a block diagram that illustrates an embodiment of a computer 302 that may implement the functions of the payment gateway 206, as described herein. The computer 302 accordingly may be referred to as the “payment gateway computer.”

Referring now to FIG. 3, the payment gateway computer 302 may, in its hardware aspects, resemble a typical server computer and/or mainframe computer, but may be controlled by software to cause it to function as described herein. For example, the payment gateway computer 302 may be constituted by commercially available server computer hardware and/or by cloud-based computing resources.

The payment gateway computer 302 may include a computer processor 300 operatively coupled to a communication device 301, a storage device 304, an input device 306 and an output device 308. The communications device 301, the storage device 304, the input device 306 and the output device 308 may all be in communication with the processor 300.

The computer processor 300 may be constituted by one or more conventional processors. Processor 300 operates to execute processor-executable steps, contained in program instructions described below, so as to control the payment gateway computer 302 to provide desired functionality.

Communication device 301 may be used to facilitate communication with, for example, other devices (such as customer devices, e-commerce servers and other components of the payment system 200). For example, communication device 301 may comprise numerous communication ports (not separately shown), to allow the payment gateway computer 302 to communicate simultaneously with a large number of other devices, including communications as required to simultaneously handle numerous requests for transactions and issuance of tokens.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the payment gateway computer 302, executed by the processor 300 to cause the payment gateway computer 302 to function as described herein.

The programs may include one or more conventional operating systems (not shown) that control the processor 300 so as to manage and coordinate activities and sharing of resources in the payment gateway computer 302, and to serve as a host for application programs (described below) that run on the payment gateway computer 302.

The programs stored in the storage device 304 may also include a software communications interface 310 that programs the processor 300 to facilitate communications between the payment gateway computer 302 and customer/user devices. Also, the storage device 304 may store a software communications interface 312 that programs the processor 300 to facilitate communications between the payment gateway computer 302 and merchants/e-commerce servers. Still further, the storage device 304 may store a software communications interface 314 that programs the processor 300 to facilitate communications between the payment gateway computer 302 and the payment network 110a.

The storage device 304 may also store a token issuance application program 316. The token issuance application program 316 may program the processor 300 to enable the payment gateway computer 302 to perform functions required for the payment gateway 206 to issue tokens as described herein. This may include interactions with customer devices by which users request issuance of tokens. This may further include communications with account issuers via the payment network 110a to support holding of funds at the issuers to back up the tokens issued by the payment gateway.

In addition, the storage device 304 may store a transaction handling application program 318. The transaction handling application program 318 may program the processor 300 to enable the payment gateway computer 302 to handle the payment portion of e-commerce transactions, as described herein.

The storage device 304 may also store, and the payment gateway computer 302 may also execute, other programs, which are not shown. For example, such programs may include a reporting application, which may respond to requests from system administrators for reports on the activities performed by the payment gateway computer 302. The other programs may also include, e.g., database management software, device drivers, etc.

The storage device 304 may also store a token database 320. The token database may store token entries (not separately shown) that are represented by tokens issued by the payment gateway computer 302. The token entries may be referenced by the payment gateway computer 302 to determine whether funds are available to support requested transactions. The token entries may also be modified by the payment gateway computer 302 to reflect charging of payment transactions using the respective tokens that represent the token entries.

Moreover, the storage device 304 may store one or more databases 322 required for operation of the payment gateway computer 302.

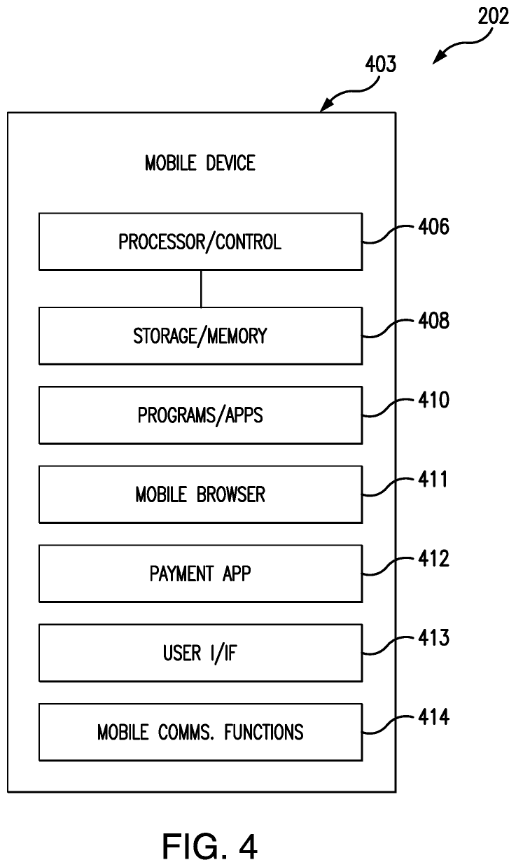

FIG. 4 is a simplified block diagram of an example of the customer device 202 shown in FIG. 2. In this example embodiment, the customer device 202 is illustrated as a mobile device such as a smartphone.

The customer device 202 may include a housing 403. (In cases where the customer device 202 is a desktop computer, the customer device 202 may include several housings including the “tower” housing, the keyboard housing, etc.)

The customer device 202 further includes a processor/control circuit 406, which is contained within the housing 403. Also included in the customer device 202 is a storage/memory device or devices (reference numeral 408). The storage/memory devices 408 are in communication with the processor/control circuit 406 and may contain program instructions to control the processor/control circuit 406 to manage and perform various functions of the customer device 202. Programs/applications (or “apps”) that are stored in the storage/memory devices 408 are represented at block 410 in FIG. 4, and may be accessed to program the processor/control circuit 406. In view of its pertinence to the teachings of this disclosure, a browser program is shown separately from the programs/apps 410 and is represented by block 411. In the same vein, a payment app 412 is depicted separately from the other programs/apps 410.

Physical and/or software aspects of the device user interface, including input/output (I/O) devices, are represented at block 413 in FIG. 4.

As is typical for computing devices, the customer device 202 may include communications components as represented by block 414. The communications components 414 allow the customer device 202 to engage in data communication with other devices. For example, the communications components 414 may support mobile communications functions that include voice and data communications via a mobile communications network (not shown). The data communication capabilities of the customer device 202 may allow for online browsing sessions and interactions with webpages via the browser 411 and/or may support “in-app” communication sessions.

From the foregoing discussion, it will be appreciated that the blocks depicted in FIG. 4 as components of the customer device 202 may in effect overlap with each other, and/or there may be functional connections among the blocks which are not explicitly shown in the drawing.

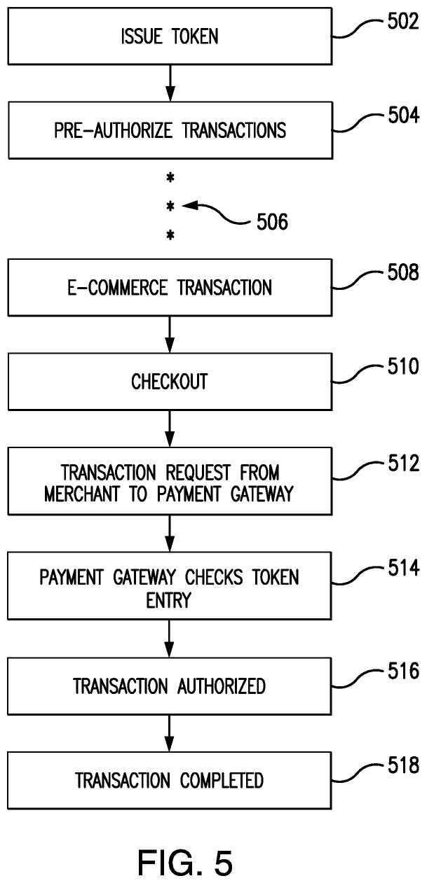

FIG. 5 is a flow chart that illustrates a process that may be performed in the payment system 200 according to aspects of the present disclosure.

At 502 in FIG. 5, a token is issued by the payment gateway computer 302. The token may be issued to a user in response to a request from the user communicated from the customer device 202 to the payment gateway computer 302. The issuance process may include the user establishing a user account with the payment gateway computer 302. As part of this process step, the user may communicate, to the payment gateway computer 302, the user's PAN (primary account number) for the payment account that is to back-up the pre-authorization of payments via token using the token issued at this step. In some embodiments, the participation of the customer device 202 in this process step may be facilitated/managed by the payment app 412 referred to above in connection with FIG. 4. In some embodiments, the token may be in the same format as a typical PAN—e.g., a 16-digit number including a check digit. In some embodiments, the token may be restricted to use in e-commerce transactions. It may, but need not, be the case that use of the token may be restricted to transactions with a single merchant, or to transactions with a predetermined group of merchants.

At 504 in FIG. 5, the payment gateway computer 302 manages pre-authorization of one or more transactions to be performed using the token. This also may occur at the request of the user 103, transmitted to the payment gateway computer 302 from the customer device 202 (via operation of the payment app 412 in the customer device 202). In arranging for pre-authorization, the payment gateway computer 302 may transmit a pre-authorization request via the payment network 110a to the issuer 112a of the user payment account identified by the PAN submitted to the payment gateway computer 302 by the user. If the user's payment account is in order and has adequate funds/credit available, the issuer 112a may put a hold on sufficient funds/credit to cover the requested amount of pre-authorized token transactions as requested by the payment gateway computer 302. As just one example of many different possibilities, the pre-authorization request may be for five token transactions of up to $50.00 each. In such a case, the issuer 112a may put a hold on the user's payment account in the amount of $250.00 (i.e., 5×$50.00).

Upon receiving confirmation that the issuer 112a has pre-authorized the requested token transactions, the payment gateway computer 302 may update the corresponding token entry in the token database 320 (FIG. 3) to indicate the availability of the token transactions for which pre-authorization was requested and provided.

Steps 502 and 504 may be thought of as a set-up process. Following the set-up process, a lapse of time may occur, represented by ellipsis 506. Following the lapse of time (which may be minutes, hours, days or weeks), the user 103 operates his/her customer device 202/browser 412 to engage in an online shopping transaction (step 508) via interaction between the browser 412 and the e-commerce server computer 104a (FIG. 2). It is assumed that the user 103 selects one or more items for purchase in the transaction, and proceeds to the checkout phase (block 510) of the online shopping transaction.

At 512 in FIG. 5, in connection with performance of the checkout phase, The e-commerce server 104a may transmit to the payment gateway computer 302 a request for authorization of a payment transaction utilizing the token issued at 502 by the payment gateway computer 302. It may be assumed that the payment gateway computer 302 receives the request from the e-commerce server 104a, and that the request includes the token. It may have been the case that the user 103 arranged for the token to be on-file with the e-commerce server 104a, and that the e-commerce server 104a automatically accessed the token in its files and included the token in the payment transaction request. The transaction request may include a transaction amount that represents the amount due from the user to the merchant for the e-commerce transaction in question.

At 514, the payment gateway computer 302 may check the token entry (in the token database 320) that corresponds to the token included in the transaction request received at 512. The purpose of this step is for the payment gateway computer 302 to determine that the token is valid and in good standing and that there is a sufficient quantity of pre-authorized funding in the token entry to support the requested transaction. The step may also include determining that any restrictions on the use of the token are satisfied.

Assuming that all proves to be in order at step 516, the payment gateway computer 302 may authorize (step 516) the payment transaction (and associated e-commerce transaction) requested at 512. In doing so, the payment gateway computer 302 may communicate the authorization to the e-commerce server 104a. This may occur very rapidly in comparison to a conventional payment account transaction (as described above in connection with FIG. 1), because in connection with the transaction of steps 508-516 it is not the case that the transaction request is transmitted via the payment network to the user's account issuer. Rather, the authorization process is streamlined by taking place entirely at the payment gateway 206. This process may take less than a second and may noticeably improve the user experience in connection with e-commerce transactions that utilize the payment process as described in connection with FIG. 5.

In connection with authorizing the transaction at 516, the payment gateway computer 302 may modify the corresponding token entry in the token database 320 to indicate that the transaction amount is effectively being charged to the token/token entry in question.

Whether or not the payment gateway is operated in common with the payment network shown in FIG. 2, the tokens issued by the payment gateway may be backed by payment accounts issued in conjunction with the same payment network or with any other payment network.

An additional advantage of the payment technique disclosed herein is that the user's PAN is not exposed to the merchant, thereby avoiding the risk of the PAN being compromised via a breach of the merchant's data processing systems. In some embodiments, greater security is achieved by restricting the token to use with a particular merchant. Contrastingly, greater convenience may be achieved by having the user authorize the token to be on file with a considerable number of merchants.

In an embodiment described above, the user requested pre-authorization of token transactions via interaction with the payment gateway. Alternatively, however, this may be done via user interaction with the merchant or acquirer.

In some embodiments, according to an additional feature, before submitting the transaction request, the e-commerce server may check with the payment gateway computer 302 to determine whether pre-authorized funding is available to support funding the transaction via the token on-file with the e-commerce server. If not, the e-commerce server may return an error message to the user in lieu of submitting the transaction request and having the request declined by the payment gateway computer 302.

In some embodiments, the payment gateway 206 is associated with or operated by the merchant's acquirer bank.

Following transaction authorization at 516, the process of FIG. 5 may advance to 518. At 518, the e-commerce server 104a may complete the online shopping transaction in a conventional manner. For example, the e-commerce server 104a may download to the customer device 202 an indication that that transaction is complete, and fulfillment of the transaction by the merchant may then proceed in due course.

At a settlement phase of the transaction, the payment gateway computer 302 may cooperate with the payment network and the account issuer to arrange for settlement of the transaction amount with the acquirer bank for the benefit of the merchant.

In embodiments described above, tokenization at a payment gateway of payment accounts—and authorization of transactions at a payment gateway—have been applied in the context of e-commerce transactions. In addition or alternatively, such measures may also apply with respect to POS transactions.

In some embodiments, an automatic top-up function may be provided such that the user can set an auto-debit facility for gateway tokens. For example, if the value present at the payment gateway falls below, say, USD 5.00, then the payment gateway may automatically request pre-authorization of a new token to top-up the value available at the payment gateway. This may promote, in general, faster payment transactions.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of at least some steps and/or omitting one or more steps.

As used herein and in the appended claims, the term “payment card system account” includes a credit card account or a deposit account that the account holder may access using a debit card. The terms “payment card system account” and “payment card account” and “payment system account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present disclosure has been set forth in connection with specific exemplary embodiments, it should be understood that various changes, substitutions, and alterations apparent to those skilled in the art can be made to the disclosed embodiments without departing from the spirit and scope of the disclosure as set forth in the appended claims.

1. (canceled)

2. A method comprising:
pre-authorizing, at a payment gateway, a token entry, the token entry represented by a payment token,
receiving, at the payment gateway, from a merchant, a transaction request, the transaction request including said payment token; the transaction request related to an e-commerce transaction involving the merchant;
responding, by the payment gateway to the payment request by authorizing said e-commerce transaction; and
charging, at the payment gateway, said e-commerce transaction to the token entry;
wherein the pre-authorizing step includes holding funds at a payment card account issued by an account issuer, the account issuer different from the payment gateway.

3. The method of claim 2, wherein the pre-authorizing step includes routing a request for said pre-authorizing from the payment gateway to the account issuer via a payment network.

4. The method of claim 3, wherein said transaction request does not pass through the payment network and is not routed to the account issuer prior to said authorizing of said e-commerce transaction.

5. The method of claim 2, further comprising:
issuing said payment token by the payment gateway.

6. The method of claim 2, wherein said payment token received in the transaction request was stored on file by the merchant.

7. The method of claim 2, wherein the payment gateway is operated by an operator of the payment network.

8. (canceled)

9. An apparatus comprising:
a processor; and
a memory in communication with the processor, the memory storing program instructions, the processor operative with the program instructions to perform functions as follows:
pre-authorizing, at a payment gateway, a token entry, the token entry represented by a payment token,
receiving, at the payment gateway, from a merchant, a transaction request, the transaction request including said payment token; the transaction request related to an e-commerce transaction involving the merchant;
responding, by the payment gateway, to the payment request by authorizing said e-commerce transaction; and
charging, at the payment gateway, said e-commerce transaction to the token entry;
wherein the pre-authorizing function includes holding funds at a payment card account issued by an account issuer, the account issuer different from the payment gateway.

10. The apparatus of claim 9, wherein the pre-authorizing function includes routing a request for said pre-authorizing from the payment gateway to the account issuer via a payment network.

11. The apparatus of claim 10, wherein said transaction request does not pass through the payment network and is not routed to the account issuer prior to said authorizing of said e-commerce transaction.

12. The apparatus of claim 9, wherein the process is further operative with the program instructions to cause said payment gateway to issue said payment token.

13. The apparatus of claim 9, wherein said payment token received in the transaction request was stored on file by the merchant.

14. The apparatus of claim 9, wherein the payment gateway is operated by an operator of the payment network.

15. (canceled)

16. A non-transitory memory device, the device storing program instructions for programming a processor to perform functions as follows:
pre-authorizing, at a payment gateway, a token entry, the token entry represented by a payment token,
receiving, at the payment gateway, from a merchant, a transaction request, the transaction request including said payment token; the transaction request related to an e-commerce transaction involving the merchant;
responding, by the payment gateway, to the payment request by authorizing said e-commerce transaction; and
charging, at the payment gateway, said e-commerce transaction to the token entry;
wherein the pre-authorizing function includes holding funds at a payment card account issued by an account issuer, the account issuer different from the payment gateway.

17. The non-transitory memory device of claim 16, wherein the pre-authorizing function includes routing a request for said pre-authorizing from the payment gateway to the account issuer via a payment network.

18. The non-transitory memory device of claim 17, wherein said transaction request does not pass through the payment network and is not routed to the account issuer prior to said authorizing of said e-commerce transaction.

19. The non-transitory memory device of claim 16, wherein the program instructions are also for programming the processor to cause the payment gateway to issue the payment token.

20. The non-transitory memory device of claim 16, wherein said payment token received in the transaction request was stored on file by the merchant.
